(19) United States
(12) Patent Application Publication
(10) Pub. No.: US 2013/0279184 A1
(43) Pub. Date: Oct. 24, 2013

(54) LIGHTING APPARATUS

(71) Applicant: Takafumi Yamashita, Osaka-shi (JP)

(72) Inventor: Takafumi Yamashita, Osaka-shi (JP)

(73) Assignee: SHARP KABUSHIKI KAISHA, Osaka-shi, Osaka (JP)

(21) Appl. No.: 13/822,306

(22) PCT Filed: Oct. 5, 2011
(86) PCT No.: PCT/JP11/72966

§ 371 Date: Mar. 12, 2013

(30) Foreign Application Priority Data
Oct. 25, 2010 (JP) 2010-238922

(51) Int. Cl. F21V 19/00; F21V 21/30

(52) U.S. Cl. CPC F21V 19/00; F21V 21/30
USPC 362/427; 362/382

(57) ABSTRACT

A lighting apparatus includes a light source unit that has a light source, a holding member (supporting frame) that holds the light source unit, and a locking mechanism that locks by the operation of an operating piece in a condition where the light source unit is held by the supporting frame. The locking mechanism is arranged for containing the operating piece inside the lighting apparatus. The operating piece to which an external force is applied is contained in the lighting apparatus in the locking condition. Thus, it is possible to avoid the release of the lock, and prevent the light source unit from being detached by unintentionally applied external force or the like.

This application is the national phase under 35 U.S.C. §371 of PCT International application No. PCT/JP2011/072966 which has an International filing date of Oct. 5, 2011 and designated the United States of America.

### FIELD

The present invention relates to a lighting apparatus in which a light source unit having a light source is held by a holding member fixed on a locating portion such as a ceiling surface.

### BACKGROUND

Recently, a lighting apparatus having a solid light emitter typified by the light emitting diode (LED) as a light source is widely spread, as an alternative to a conventional lighting apparatus having an incandescent lamp, fluorescent lamp and the like as a light source. A lighting apparatus located on a ceiling in a living room is known one of such lighting apparatuses (for example, see Japanese Patent Application Laid-Open No. 2010-153314).

The lighting apparatus shown in Japanese Patent Application Laid-Open No. 2010-153314 includes a supporting frame embedded in and fixed to the ceiling, and a light source unit (body of the apparatus) attached to the supporting frame. The light source unit is configured with plural LEDs, as a light source, which are aligned on the bottom surface of the rectangular housing, and with an opening which is opposite to the bottom surface and covered by a translucent plate. The size of the supporting frame is enough for containing the light source unit.

The light source unit includes a fastening piece at one side. The fastening piece is hooked by one side end of the supporting frame. The light source unit is rotated about this hooking portion, and restrained within the supporting frame by a stopper provided at the other side, in order to be attached.

The lighting apparatus is utilized in this condition, and light from each LED of the light source unit is reflected by the inner surface of the housing and partially reflected by the inner surface of the translucent plate. Thus, the light evenly dispersed on the whole surface of the translucent plate is emitted to the outside.

### SUMMARY

In the lighting apparatus of Japanese Patent Application Laid-Open No. 2010-153314, the light source unit can be detached by releasing the restraint of the stopper, with the reverse order of the attaching procedure. This detachment is performed for the inspection repair or the replacement of the light source unit.

The stopper is a rotation axis supported to the light source unit (or supporting frame) in the rotatable manner, and includes a stopper piece that protrudes outwardly. It is configured that the restraining condition is obtained when the stopper piece moving in response to the rotation operation of the stopper is engaged with a part of the supporting frame (or light source unit). The stopper has a screw head exposed to the outside of the light source unit (or supporting frame). When the screw head is operated with a screwdriver, the stopper piece rotates together with the stopper and moves between the engagement position and non-engagement position.

However, the screw head positioning at the operation edge is exposed to the outside, in the lighting apparatus having such a stopper. Thus, it may cause a problem that a function due to unintentional force externally applied in the normal use condition or the like makes the stopper rotate, the engagement condition is released and the light source unit is detached from the supporting frame.

The present invention has an object to prevent the light source unit from being detached by the function of unintentional force applied externally or the like.

A lighting apparatus according to the present invention has a light source unit that includes a light source, a holding member that holds the light source unit, and a locking mechanism that locks the light source unit to the holding member in a holding condition with an operation of a lock operating unit, wherein the locking mechanism is arranged for keeping the lock operating unit contained in the lighting apparatus, so as to prevent a lock from being released by a function of an unintentional force externally applied in a locking condition.

In the present invention, the locking mechanism locks the light source unit held by the holding member in a holding condition, and the lighting apparatus internally contains the lock operating unit of the locking mechanism in the locking condition. Therefore, it is possible to prevent the lock from being released by the function of unintentional force applied externally or the like.

In addition, a lighting apparatus according to the present invention comprises the lock operating unit that operates to shift from a lock releasing condition to the locking condition directly by hand.

In this invention, it is possible directly by hand to make the lock operating unit operate for shifting the lock releasing condition to the locking condition. Thus, tools are not required for locking in the holding condition where the light source unit is held by the holding member. Therefore, it is possible to facilitate the work.

In addition, a lighting apparatus according to the present invention has the locking mechanism which comprises: a fastening unit that is fastened to one of the light source unit and the holding member, by the operation of the lock operating unit; and restricting means for restricting a release of a fastening condition of the fastening unit.

In this invention, the release of the fastening condition for the fastening unit is restricted. Thus, it is possible to prevent the locking condition of the locking mechanism from being released unintentionally.

In addition, a lighting apparatus according to the present invention has the locking mechanism which comprises a rotation axis that pivots the lock operating unit and rotates the lock operating unit to move the fastening unit.

In this invention, the lock operating unit and the fastening unit are pivoted about the rotation axis. Thus, it is possible with a simple mechanism to link the lock operating unit and the fastening unit. Furthermore, it is possible to implement the mechanism that internally contains the lock operating unit in the lighting apparatus at a time when the fastening unit is fastened to the light source unit or the holding member.

In addition, a lighting apparatus according to the present invention has the holding member which comprises a pivoting unit that pivots the light source unit at another end side opposing to one end side on which the locking mechanism is positioned.

In this invention, the pivoting unit pivoting the light source is arranged on another end side opposite to one end side at which the locking mechanism is positioned. Thus, the light source unit can be suspended by the pivoting unit even if the locking mechanism is released. Therefore, it is possible to prevent the dropping of the light source unit. Furthermore, it is possible to improve the attachment work of the lighting apparatus, because the lock is implemented by the operation only for the lock operating unit positioned at one side where the locking mechanism is positioned.

### Effects of the Invention

In the lighting apparatus according to the present invention, it is possible to avoid the possibility that the light source unit is detached by a function of unintentional force externally applied or the like.

The above and further objects and features will more fully be apparent from the following detailed description with accompanying drawings.

### BRIEF DESCRIPTION OF THE DRAWINGS

FIG. 1 is a perspective view for showing an external appearance of a lighting apparatus regarding an embodiment 1.

FIG. 2 is a perspective view for showing an external appearance of the lighting apparatus regarding the embodiment 1.

FIG. 3 is an exploded perspective view for showing the lighting apparatus regarding the embodiment 1.

FIG. 4 is a partial enlarged view of FIG. 2.

FIG. 5 is an explanation view for showing an assembly procedure of the lighting apparatus regarding the embodiment 1.

FIG. 6 is a perspective view for showing an external appearance of a lighting apparatus regarding an embodiment 2.

FIG. 7 is a perspective view for showing an external appearance of the lighting apparatus regarding the embodiment 2.

FIG. 8 is a partial enlarged view of FIG. 6.

FIG. 9 is a perspective view for showing a condition in which a light source unit 1 of the lighting apparatus regarding the embodiment 2 is detached.

FIG. 10 is a perspective view for showing an external appearance of a lighting apparatus regarding an embodiment 3.

FIG. 11 is a perspective view for showing an external appearance of the lighting apparatus regarding the embodiment 3.

FIG. 12 is a perspective view for showing an external appearance of the lighting apparatus regarding the embodiment 3.

FIG. 13 is a perspective view for showing an external appearance of the lighting apparatus regarding the embodiment 3.

### DETAILED DESCRIPTION

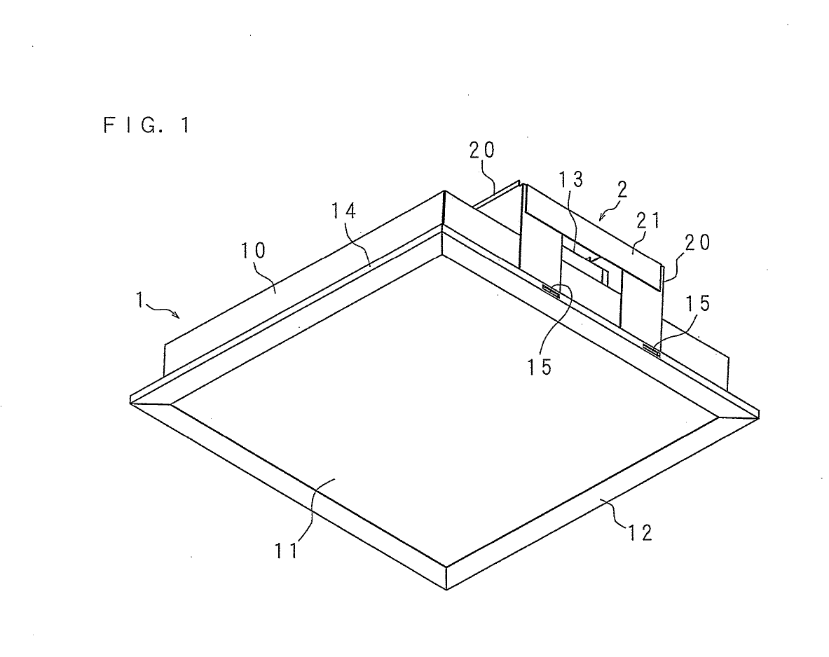

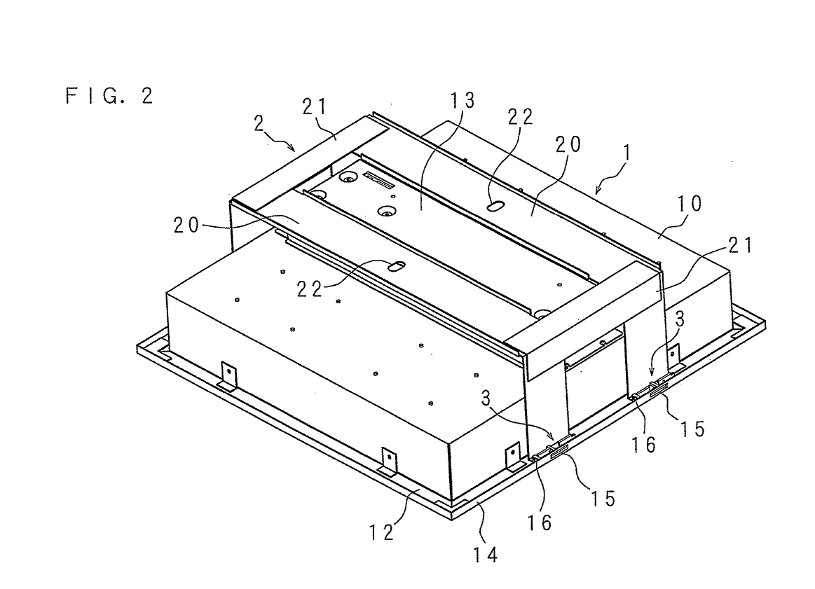

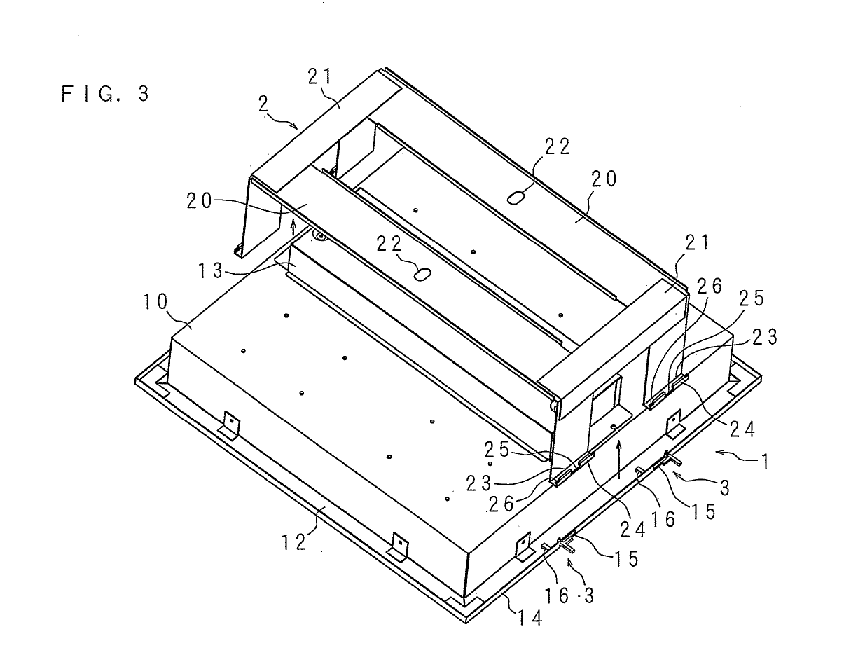

The present invention is explained below in reference to drawings showing embodiments of the present invention. FIGS. 1 and 2 are perspective views for showing an external appearance of a lighting apparatus regarding the embodiment 1. FIG. 3 is an exploded perspective view for showing the lighting apparatus regarding the embodiment 1. FIG. 1 shows a condition viewed from a front surface (light emitting surface) side of a light source unit, and FIGS. 2 and 3 show conditions viewed from a back surface side of the light source unit.

As shown in FIGS. 1-3, the lighting apparatus includes a light source unit 1 and a supporting frame 2 that works as a holding member for holding the light source unit 1. The light source unit 1 includes an external housing 10 that is formed in a rectangular shape and opens an entire surface at one side, a translucent plate 11 that is attached to cover the opening of the external housing 10, and a collar portion 12 that is arranged around the opening of the external housing 10. Inside the external housing 10, many light source modules (not shown in drawings) are aligned in both up-down and left-right directions on the bottom surface opposing to the opening.

The light source module is configured to emit white to warm white light, for example, as consisting of a white LED that is sealed by resin including fluorescent material. It should be noted that the light source module may be configured to utilize EL (Electro Luminescence) or the like that is a solid light emitter, fluorescent lamp or the like other than the LED, as the light source. As shown in FIGS. 2 and 3, a circuit box 13 is fixed on an external surface of a bottom plate of the external housing 10. The light source modules arranged inside the external housing 10 are connected to a power circuit configured in the circuit box 13, and the light source modules emit light based on the power supply from the power circuit.

A reflecting plate (not shown in drawings) is attached on an internal surface of the external housing 10. Thus, it is configured that light emitted from each light source module comes to the opening of the external housing 10, directly or reflected by the reflecting plate. The reflecting plate is a resin plate having both insulating property and light-reflecting property. For example, resin mixed with white pigment, such as titanium oxide, is molded in a plate shape so as to make the reflecting plate. It may be configured that the external housing 10 is entirely made of resin having insulating property and light-reflecting property and that the external housing 10 works as the reflecting plate.

The translucent plate 11 consists of a plate, for example, which is made of polycarbonate resin having creamy white color. The translucent plate 11 is sandwiched between the opening of the external housing 10 and an inner periphery of the collar portion 12, and is attached to cover the entire surface of the opening of the external housing 10. Total reflection by the reflecting plate at the internal surface of the external housing 10 and partial reflection by the translucent plate 11 are repeatedly occurred on light emitted from the light source module, and then the light is emitted out evenly from the entire surface of the translucent plate 11 to illuminate the vicinity.

As shown in FIGS. 1-3, the collar portion 12 has an appropriate width extending outside of the translucent plate 11, and a rising portion 14 bending with substantial right angle toward the attachment side of the external housing 10 is arranged at the outer periphery of the collar portion 12. A pair of window holes 15, 15 opening in rectangle shapes is arranged on one side of the rising portion 14, and the window holes 15, 15 are respectively located at positions equally away from the center of the one side. As configuring a locking mechanism described later, stoppers 3, 3 are attached on the collar portion 12 at the internal side of the window holes 15, 15, respectively. In addition, fastening claws 16, 16 are arranged to protrude on the edge portion of the rising portion 14. Positions of engaging claws 16, 16 are separated to the same side from respective window holes 15, 15. It should be noted that a notch may be utilized instead of the window hole 15.

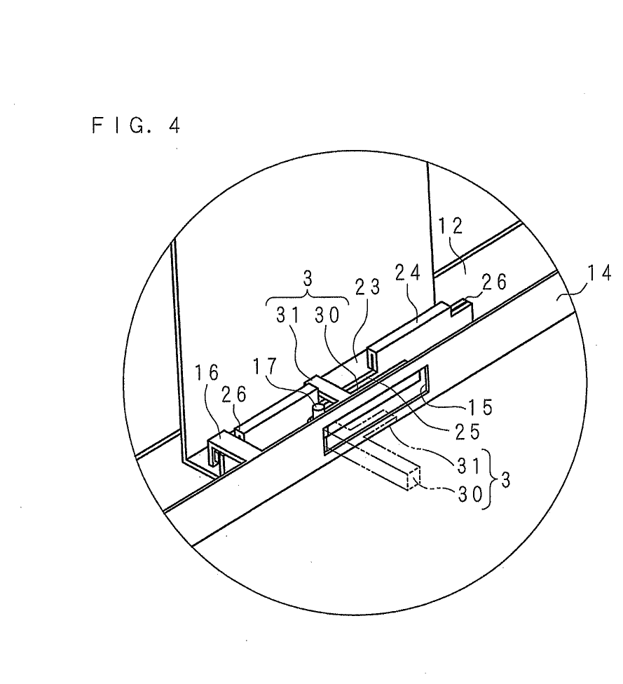

FIG. 4 is a partial enlarged view of FIG. 2, and shows a neighboring part of one window hole 15. As shown in this drawing, a supporting axis 17 is arranged for the stopper 3 on the top surface of the collar portion 12. The supporting axis 17 vertically rises at a position adjacent to and inside of the rising portion 14, on one side in the longitudinal direction of the window hole 15, to work as a rotation axis configuring the locking mechanism. The stopper 3 includes a rectangular rod-like operating piece 30 working as a lock operating unit, and a functioning piece 31 protruding perpendicularly at the midway portion of the operating piece 30 and working as a fastening unit. The stopper 3 is attached, to pivot one edge portion of the operating piece 30 about the supporting axis 17, to rotate the operating piece 30 about the supporting axis 17 on a surface parallel to the top surface of the collar portion 12, and to become rotatable between a locking condition shown by solid lines in the figure and a lock releasing condition shown by two-dot chain lines in the drawing. When the operating piece 30 of the stopper 3 is rotated to generate the locking condition, it is possible to lock the light source unit 1 that has been held by the supporting frame 2 working a holding member. In other words, the locking condition generated by the locking mechanism is kept, and thus it is possible to prevent the light source unit 1 from being detached and dropped from the supporting frame 2.

When the stopper 3 is in the locking condition, the operating piece 30 is contained in the top portion of the collar portion 12 along internal side of the rising portion 14 and the functioning piece 31 is extending inwardly at the midway portion of the operating piece 30. In addition, when the stopper 3 is in the lock releasing condition, the operating piece 30 protrudes to the external side of the collar portion 12 through the window hole 15 and the functioning piece 31 is extending at the midway portion of the operating piece 30 along the external side of the rising portion 14.

Therefore, the stopper 3 in the lock releasing condition can be easily shifted to the engagement position, with the procedure for gripping the operating piece 30 that protrudes from the window hole 15 and rotating the operating piece 30 about the supporting axis 17 to push into the window hole 15. In other words, the operating piece 30 can be shifted from the lock releasing condition to the locking condition by direct hand. Therefore, it is possible to facilitate the work because tools are not required for attaching the light source unit 1 held by the supporting frame 2. On the other hand, the operating piece 30 of the stopper 3 in the locking condition is internally contained inside the collar portion 12 that is a part of the light source unit 1, and thus a portion to which an external force of the locking mechanism is applied is not externally exposed. Therefore, it is possible to prevent external force and the like from being unintentionally applied at the external side of the collar portion 12, and to prevent the lock from being released. Furthermore, while the operating piece 30 is contained at the internal side from the window hole 15, there are no space between the window hole 15 and the operating piece 30 which allows the direct touch of the operating piece 30 for returning in the lock releasing condition. For example, it is required to put a tool, such as a flat tip screwdriver, into a small clearance gap of the window hole 15, to push the tool whose tip is hooked to the operating piece 30, and to rotate the operating piece 30 for emerging the operating piece 30 from the window hole 15. Therefore, it is configured that a user cannot easily release the lock by direct hand. In short, only the clearance gap exists in the locking condition between the window hole 15 and the operating piece 30, and the clearance gap can allow only the insertion of a tool, such as a flat tip screwdriver. Thus, it is possible to reduce the risk that a user unintentionally releases the lock and then touches a live part inside the lighting apparatus.

Similar stopper 3 is arranged at the internal side of another window hole 15. This stopper 3 is configured to implement the engagement position and the lock releasing condition with a rotation operation reverse to the rotation operation of the stopper 3 shown in FIG. 4. In other words, a clockwise rotation of one stopper 3 shown in FIG. 4 causes the shift from the engagement position to the lock releasing condition, but an anti-clockwise rotation of the other stopper 3 causes the shift from the engagement position to the lock releasing condition. In FIG. 3, both the stoppers 3, 3 are in the lock releasing condition. Thus, it is apparent that directions of rotation operations for these stoppers 3, 3 are reverse to each other.

The engaging claw 16 is arranged at a position spaced away by a predetermined length from the attaching portion of the stopper 3. As shown in FIG. 4, the engaging claw 16 is arranged to protrude inwardly from the top edge of the rising portion 14, and the tip portion of the engaging claw 16 is bent with substantial right angle toward the top surface of the collar portion 12. A similar engaging claw 16 is also arranged adjacent to the attaching portion of the other stopper 3. As shown in FIGS. 2 and 3, this engaging claw 16 is arranged on a position at the same side as the engaging claw 16 shown in FIG. 4 and with the similar distance to the engaging claw 16 shown in FIG. 4.

Furthermore, the window holes 15, 15, the stoppers 3, 3 and the engaging claws 16, 16 described above are similarly arranged on another side of the collar portion 12 parallel to the one side shown in drawings.

Although arranged at the internal side of the other window hole 15, a similar stopper 3 is configured to implement the locking condition and lock releasing condition by the reverse rotation operation to the rotation operation of the stopper 3 shown in FIG. 4. In other words, a clockwise rotation of one stopper 3 shown in FIG. 4 implements the shift from the locking condition to the lock releasing condition, but an anti-clockwise rotation of the other stopper 3 implements the shift from the locking condition to the lock releasing condition.

As described above, it is possible with a simple mechanism to link the operating piece 30 and the functioning piece 31, because of the pivoting of the operating piece 30 and the functioning piece 31 about the supporting axis 17. Therefore, it is possible to configure the mechanism that internally contains the operating piece 30 in the lighting apparatus through the window hole 15 at the same time when the operating piece 30 is rotated to fasten the functioning piece 31 to a stop concave portion 25 described later.

On the other hand, the supporting frame 2 of the lighting apparatus includes a pair of supporting legs 20, 20 formed in a gate shape, and connecting pieces 21, 21 connecting these supporting legs with a predetermined distance in a width direction. Attaching holes 22, 22 are arranged at center portions on horizontal sides of the supporting legs 20, 20, respectively. For example, the supporting frame 2 is fitted into a fixation hole opened on the ceiling as the locating portion of the lighting apparatus and anchor bolts provided in the hole are inserted into the attaching holes 22, 22 and then clamped by screw nuts, so the supporting frame 2 is fixed in such a manner that the horizontal sides of supporting legs 20, 20 face to the external side, i.e., the side opposite to the ceiling. It should be noted that the locating portion of the supporting frame 2 is not limited to the fixation hole. The supporting frame 2 may be attached directly to the ceiling, or attached to a wall surface, instead of the ceiling.

As shown in FIG. 2, the vertical sides continued with substantial right angle to the horizontal piece from both ends of horizontal side of the supporting leg 20 are spaced away by a distance required for allowing the acceptance of the external housing 10 of the light source unit 1. A caul plate 23 externally bending with substantial right angle is arranged at a top portion of each vertical side of the supporting leg 20. A supporting plate 24 is continued at the tip portion of the caul plate 23, which is rising with further substantial right angle.

The caul plate 23 and the supporting plate 24 at the top of the supporting leg 20 are shown together in FIG. 4. As shown in the drawing, the edge of the supporting plate 24 is bent in a reverse direction. A stop concave portion 25 is formed on the edge by notching over a predetermined width at a center portion in a width direction. In addition, engagement concave portions 26, 26 are formed on the edge by notching over a predetermined width at both end portions in the width direction. These stop concave portion 25 and engagement concave portions 26, 26 are similarly arranged on supporting plates 24 at tip portions of each two vertical sides of pair supporting legs 20, 20. As described later, the functioning piece 31 is fastened to the stop concave portion 25 in the locking condition of the locking mechanism.

Next, it will be explained about a method for locating the light apparatus to the ceiling or the like of the locating portion, and about a method for holding the light source unit 1 to the supporting frame 2.

The lighting apparatus is configured to attach the light source unit 1 to the supporting frame 2 fixed as described above. For the attachment of the light source unit 1, the light source unit 1 is aligned under the supporting fame 2 to keep the side of the external housing 10 upwardly as shown in FIG. 3, and the external housing 10 is fitted into a space between the vertical sides of the supporting legs 20, 20 as shown by arrows in the drawing.

The alignment of the light source unit 1 is performed in a condition where two sides of the collar portion 12 on which the stoppers 3, 3 and engaging claws 16, 16 are arranged are matched to the positions of vertical sides of the supporting legs 20, 20, as shown in FIG. 3. The fitting of the light source 1 is performed until the collar portion 12 comes into contact with the caul plate 23 at the bottom edges of the supporting legs 20, 20 in the lock releasing condition for the stoppers 3, 3.

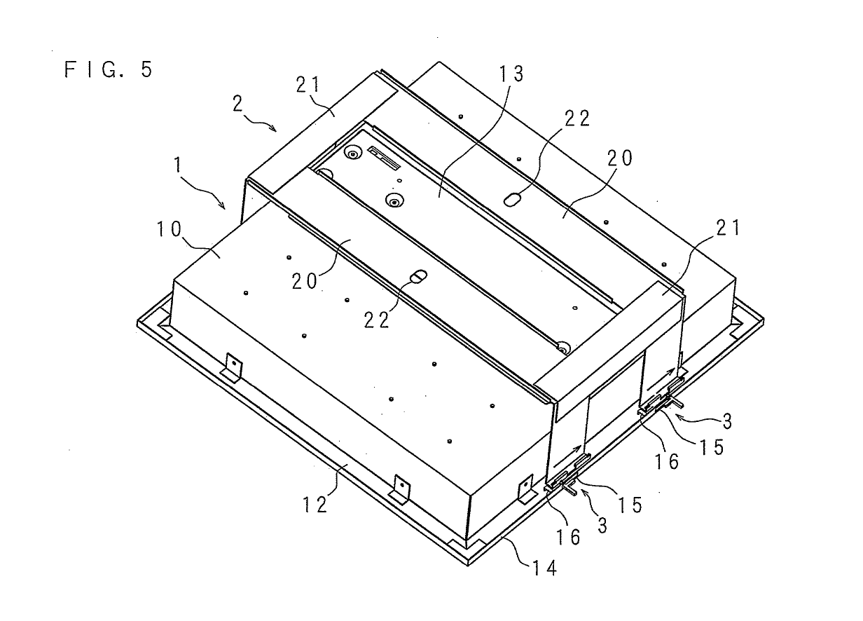

FIG. 5 is an explanation view for showing an assembly procedure of the lighting apparatus regarding the embodiment 1, and shows a condition where the light source unit 1 has been fitted. As described above, the light source unit 1 is fitted into the space between the supporting legs 20, 20 until the collar portion 12 comes into contact with the caul plate 23. At that time, the engaging claws 16, 16 arranged on the collar portion 12 are respectively positioned with predetermined distances on one side of supporting legs 20, 20, as shown in the drawing. The width of the caul plate 23 is significantly smaller than the width of the collar portion 12. The stoppers 3, 3 in the lock releasing condition are kept on a portion between the rising portion 14 of the collar portion 12 and the supporting plate 24 at the tip of the caul plate 23. Thus, the light source unit 1 can be held by the supporting frame 2 working as the holding member.

After having been fitted, the light source unit 1 is slid in a direction as shown by the arrows in FIG. 5 to bring the protruding portions of the engaging claws 16, 16 close to the supporting legs 20, 20. This slide makes the engaging claw 16 engage with the engagement concave portion 26 arranged on the same side edge portion of the supporting plate 24, as shown in FIG. 4.

When the operating piece 30 is rotated in a condition where the engaging claw 16 engages, the stopper 3 is shifted into the locking condition. At that time, the stop concave portion 25 arranged at the center portion of the supporting plate 24 is positioned at the internal side of the stopper 3, and the stopper 3 shifted into the locking condition makes the inwardly extending functioning piece 31 be fastened to the stop concave portion 25, as shown in FIG. 4.

It is preferable that a restricting means not shown in drawings is arranged on the stop concave portion 25 to restrict the release of the fastening condition of the functioning piece 31. For example, a papillary convex portion or a concave portion giving a step on the stop concave portion 25 may be utilized as the restricting means. The convex portion working as the restricting means is arranged on a side away from the functioning piece 31 in a rotating direction (a side in a clockwise direction in FIG. 4) for releasing the fastening condition of the functioning piece 31, in the locking condition of the locking mechanism shown by the solid lines in FIG. 4. When the convex portion is arranged on the stop concave portion 25, the operating piece 30 is rotated in accordance with the shift from the lock releasing condition to the locking condition. Then, when the functioning piece 31 linking to the rotation operation of the operating piece 30 is rotated to contact with the convex portion, further power is applied to the operating piece 30 to cross over the convex portion and thus to be fastened to the stop concave portion 25. The functioning piece 31 hardly cross over the concave portion to move in a direction for releasing the fastening condition, because force of gravity caused by the light source unit 1's weight affects on the stop concave portion 25 in the fastening condition of the functioning piece 31. Therefore, the arrangement of the convex portion on the stop concave portion 25 can further prevent the locking condition of the locking mechanism from being released unintentionally. Hence, it is possible to avoid the release of the lock even if it receives force caused by vibrations of the earthquake or the like other than the external force functioning to the operating piece 30. It should be noted that the size and shape of the convex portion are for allowing the stop concave portion 25 to cross over by the force that is applied when the functioning piece 31 is fastened to the stop concave portion 25 or the fastening condition is released. For example, the convex portion has a hemispherical shape including a curved surface, a pyramidal shape, such as a circular cone and triangular pyramid, a gabled projecting portion, and the like.

Furthermore, the concave portion working as the restricting means is arranged to generate a further step on the stop concave portion 25. The width of the concave portion has a size merely for fitting the functioning piece 31. The height of the concave portion has a size for allowing the functioning piece 31 fitted into the concave portion to cross over the step of the concave portion when force is applied to the stopper 3 by a tool for releasing the fastening condition of the functioning piece 31. Additionally, in the case that the side surface of the formed concave portion is inclined to the bottom surface, the functioning piece 31 can easily cross over the step when force is applied to the stopper 3 by a tool or the like. When the functioning piece 31 is fitted into the concave portion, the step of the concave portion restricts the release for the fastening condition of the functioning piece 31. Therefore, it is further possible to prevent the locking condition from being released unintentionally. Moreover, the restricting means is not limited to the concave portion or the convex portion. The contact surface of the stop concave portion 25 with the functioning piece 31 may be processed (for example, by blasting) to increase the coefficient of friction, and the release for the fastening condition of the functioning piece 31 may be restricted by the friction.

The fastening condition of the stopper 3 and the engaging condition of the engaging claw 16 as described above are similarly generated at each two tip portions of pair supporting legs 20, 20 of the supporting frame 2. The light source unit 1 can be attached by the lock of the locking mechanism at circumferential four positions, while held by the supporting frame 2.

The engaging claw 16 functions to restrict the movement of the light source unit 1 in a longitudinal direction of the horizontal side of the supporting leg 20, because of the engagement at the both sides of the supporting leg 20. In addition, the engaging claw 16 functions to restrict the movement of the light source unit 1 in a width direction of the supporting leg 20 because of the elastic force generated by the duplicatively overlapped engagement concave portion 26. In addition, the stopper 3 functions to support the weight of the light source unit 1 because of the functioning piece 31 contacting and being fastened to the stop concave portion 25, and to restrict the light source unit 1 moving away from the supporting frame 2 in a direction opposite to the locating portion, such as a ceiling. In short, it is possible to prevent the light source unit 1 from being dropped and detached from the supporting frame 2. As described above, the light source unit 1 can be attached in a condition where the movement in any directions is restricted and the light source unit 1 is held by the supporting frame 2. The lighting apparatus can be utilized for lighting the vicinity with the emitted light of the light source unit 1 described above.

In such an attachment condition, the operating piece 30 of the stopper 3 is kept at the internal side of the collar portion 12 that is a part of the light source unit 1 as described above. The shifting operation to the lock releasing condition requires putting a tool, such as a screwdriver, into the window hole 15. The stopper 3 will not shift to the lock releasing condition by the external force unintentionally applied from the outside under the normal use condition. Therefore, it is possible to avoid the unintentional detachment of the light source unit 1 under the use condition, and to implement the safe use.

In addition, the stopper 3 in the locking condition does not have a portion protruding to the outside of the light source unit 1. Thus, it is not disfigured in the use condition. The lighting apparatus regarding the embodiment 1 includes only the window hole 15 opening on the rising portion 14 of the collar portion 12 at the outer side of the light source unit 1, and the locking mechanism, such as the stopper 3 and the window hole 15, cannot be seen from a side in a light-emitting direction of the lighting apparatus. Therefore, the lighting apparatus regarding the embodiment 1 looks great in the use condition.

Furthermore, the stoppers 3, 3 respectively corresponding to the supporting legs 20, 20 shift to the lock releasing condition by reverse rotations, as described above. Therefore, it is possible to surely prevent the light source unit 1 from being detached even if force is applied by the vibration of the earthquake or the like in a direction for releasing the fastening condition of the functioning piece 31 of one stopper 3 included in the light source unit 1 in the locking condition, because no force is applied to the functioning piece 31 of the other stopper 3 in a direction for releasing the fastening condition and thus the locking condition is kept.

Moreover, the light source unit 1 in the lighting apparatus regarding the embodiment 1 can be completely detached from the supporting frame 2. Thus, the locating work of the lighting apparatus to the fixation hole, for example, arranged on the ceiling, can be implemented by the procedure of fitting only the lightweight supporting frame 2 into the fixation hole, fixing it, aligning the light source unite 1 with respect to the supporting frame 2, and then sliding it in a predetermined direction. Hence, it is possible to reduce the burden for the locating work of the lighting apparatus, especially embedded in the ceiling.

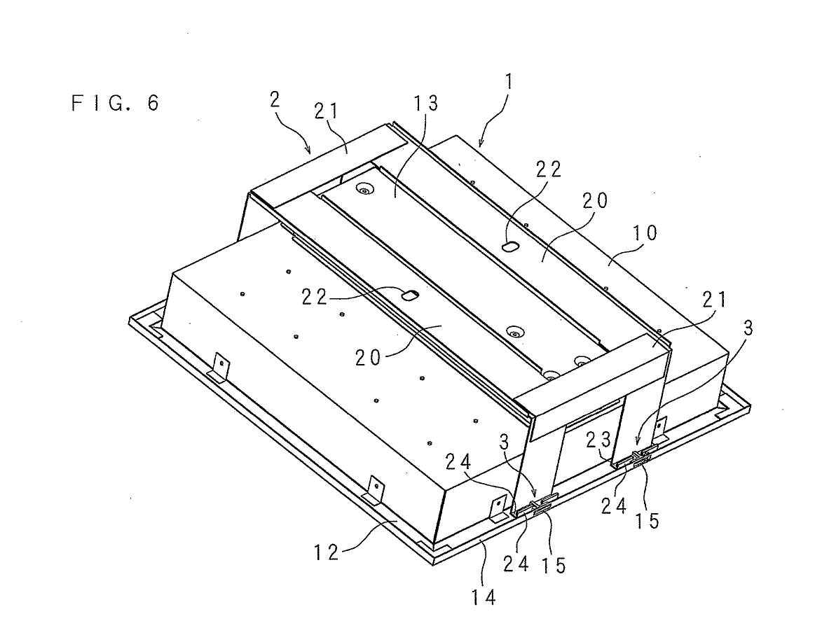

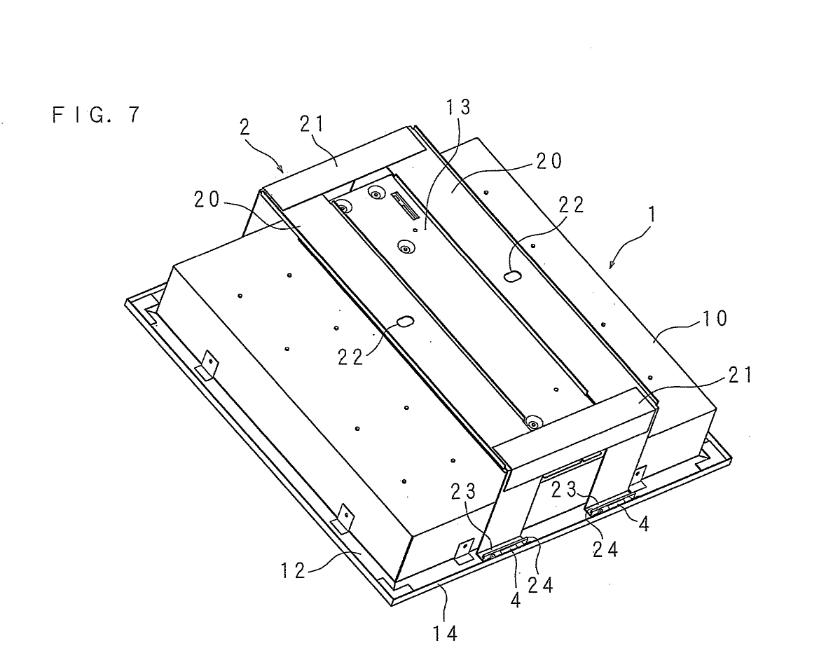

FIGS. 6 and 7 are perspective views for showing an external appearance of a lighting apparatus regarding an embodiment 2. This lighting apparatus includes the light source unit 1 and the supporting frame 2, similarly to the lighting apparatus regarding the embodiment 1. The explanation is omitted for the configuration elements similar to those of embodiment 1 among the configuration of the light source unit 1 and the supporting frame 2, with applied reference numbers the same as those of embodiment 1.

The difference between the lighting apparatuses regarding the embodiments 1 and 2 is the structure for connecting the light source unit 1 and the supporting frame 2. FIG. 6 shows a condition viewed from one side in the longitudinal direction of the supporting frame 2, and FIG. 7 shows a condition viewed from the other side in the longitudinal direction of the supporting frame 2.

The light source unit 1 is connected by the fastening of the functioning piece 31 of the stopper 3 on the tip portions of the supporting legs 20, 20 formed in the gate shape at one side of the supporting frame 2 shown in FIG. 6, and is connected by hinges 4, 4 working as pivoting units for respectively pivoting the light source unit 1 at the other side of the supporting frame 2 shown in FIG. 7.

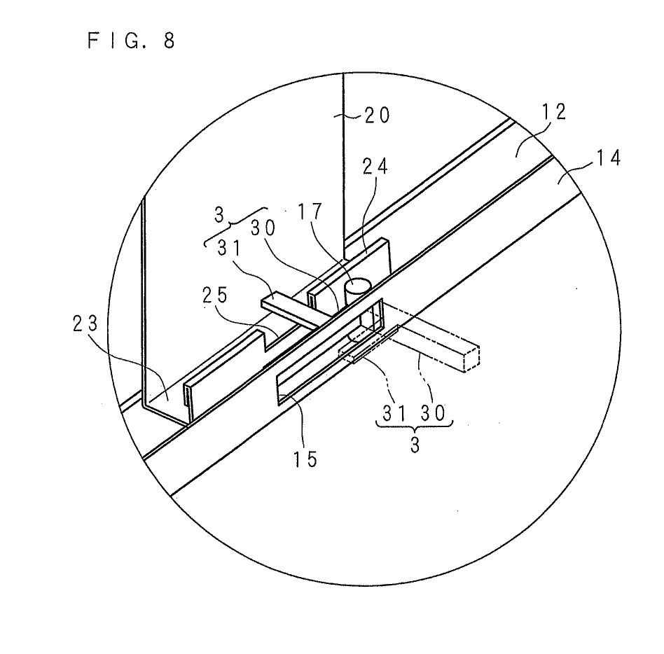

FIG. 8 is a partial enlarged view of FIG. 6, and shows a neighboring part of the window hole 15 arranged on the rising portion 14 of the collar portion 12. The stopper 3 includes the rectangular rod-like operating piece 30 working as the lock operating unit, and the functioning piece 31 protruding perpendicularly at the midway portion of the operating piece 30 and working as the fastening unit, similarly to the stopper 3 regarding the embodiment 1. The stopper 3 is attached to pivot one edge portion of the operating piece 30 about the supporting axis 17 working as the rotation axis that configures the locking mechanism arranged vertically on the top surface of the collar portion 12, and, to become rotatable between the locking condition shown by solid lines in the drawing and the lock releasing condition shown by two-dot chain lines in the drawing.

The caul plate 23 and the supporting plate 24 similar to the embodiment 1 are arranged on the tip portion of the supporting leg 20. However, only the stop concave portion 25 is arranged on the edge of the supporting plate 24, which is formed by notching over a predetermined width at the center portion in the width direction. Thus, it is configured that the stopper 3 shifted to the locking condition fastens the inwardly extending functioning piece 31 to the stop concave portion 25.

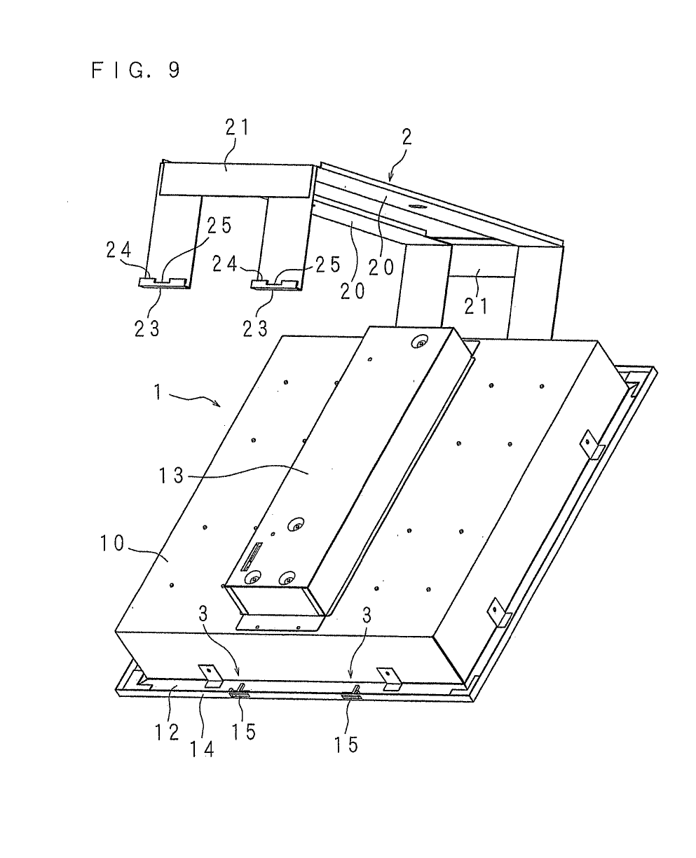

The supporting legs 20, 20 include the caul plate 23 and the supporting plate 24 on the tip portion at the other side shown in FIG. 7, too. The hinges 4, 4 are disposed between the supporting plates 24, 24 and the rising portion 14 of the collar portion 12. The light source unit 1 connected as described above can be detached at the one side from the supporting frame 2, when the lock of the stoppers 3, 3 is released and the rotation is performed about the hinges 4, 4 as the rotating axis. FIG. 9 is a perspective view for showing a condition in which one side of the light source unit 1 is detached from the supporting frame 2.

The light source unit 1 can be locked in a condition where the light source unit 1 is held by the supporting frame 2, when the light source unit 1 is rotated about the hinges 4, 4 as the rotating axis in a direction for bringing it close to the supporting frame 2 in a condition shown in FIG. 9, the collar portion 12 positioned at a side where the stoppers 3, 3 are arranged comes into contact with the caul plate 23 of the supporting legs 20, 20 positioned at the same side, the shift operation is performed for shifting the operating piece 30 of the stoppers 3, 3 into the locking condition, and then each stop concave portion 25 is fastened by the functioning piece 31. Even if the locking mechanism is unintentionally released in a condition where the light source unit 1 is held to the supporting frame 2 by the hinges 4, 4 and locked by the locking mechanism, it is possible to avoid the dropping of the light source unit 1 because the hinges 4, 4 suspend the light source unit 1 from the supporting frame 2. Furthermore, the light source unit 1 can be attached to the supporting frame 2 only by the procedure that the hinges 4, 4 are kept to support one side of the light source unit 1 and an operation is applied to the operating piece 30 of the locking mechanism arranged on the other side opposing to the one side where the hinges 4, 4 are arranged. Therefore, it is possible improve the workability for attaching the lighting apparatus.

The shifting operation of the stoppers 3, 3 into the locking condition can be implemented easily by the procedure for gripping the operating piece 30 that protrudes to the outside from the window hole 15 shown in FIG. 8 and rotating the operating piece 30 about the supporting axis 17 to push it into the window hole 15. Thus, the operating piece 30 can be operated by direct hand to shift from the lock releasing condition into the locking condition. On the other hand, the stopper 3 shifted in the locking condition is kept at the inner side of the collar portion 12 and there is no externally exposed portion to which external force can be applied. Therefore, it is possible to prevent unintentional force and the like from being externally applied to the operating piece 30 at the external side of the collar portion 12, and to prevent the lock from being released. Furthermore, the shift into the lock releasing condition requires an operation utilizing a tool, such as a screwdriver, similar to the operation in the embodiment 1. Thus, it is configured that a user cannot easily release the lock by direct hand. Therefore, it is possible to reduce the risk that a user unintentionally releases the lock and touches the live part inside the lighting apparatus.

Any of the stoppers 3, 3 at one side of the light source unit 1 and the hinges 4, 4, at the other side of the light source unit 1 are kept at the internal side of the collar portion 12 that configures a part of the light source unit 1, and have no portions protruding to the outside. Thus, it is not disfigured in the use condition. The lighting apparatus regarding the embodiment 2 includes only the window hole 15 opening on the rising portion 14 positioned at one side of the collar portion 12 at the outer side of the light source unit 1. Therefore, the lighting apparatus regarding the embodiment 2 looks great in the use condition.

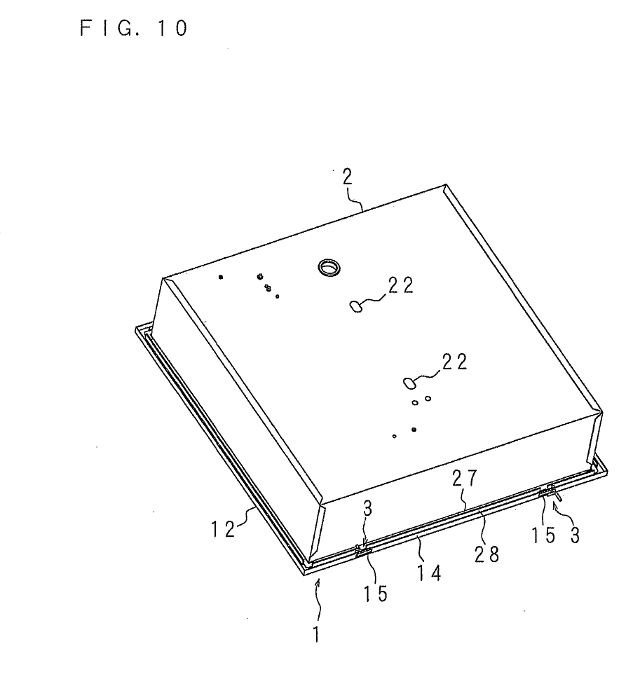

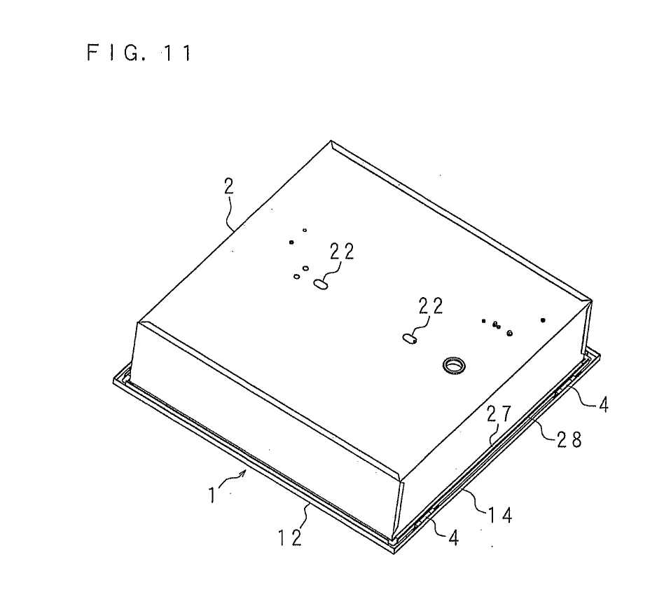

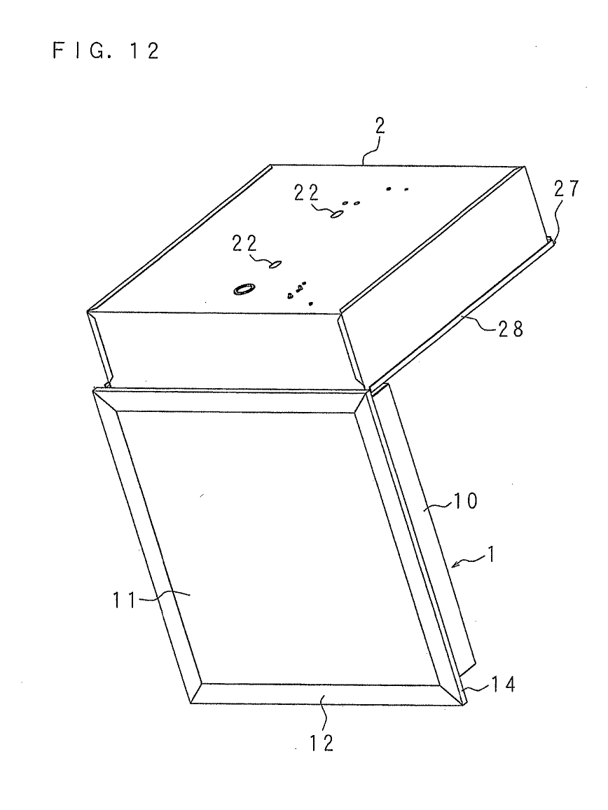

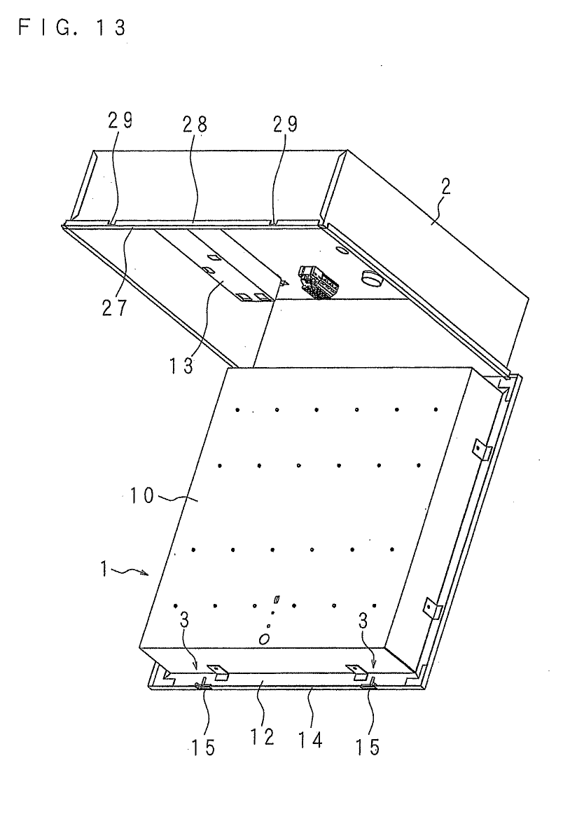

FIGS. 10-13 are perspective views for showing an external appearance of a lighting apparatus regarding an embodiment 3. This lighting apparatus includes the light source unit 1 and the supporting frame 2 that works as the holding member for holding the light source unit 1, similarly to the lighting apparatuses regarding the embodiments 1 and 2. FIGS. 10 and 11 show conditions that are viewed from different sides of the supporting frame 2 where the light source unit 1 is attached, and FIGS. 12 and 13 show conditions that are viewed from different sides of the supporting frame 2 where the light source unit 1 is detached, respectively.

The light source unit 1 includes the external housing 10 containing the light source module, the translucent plate (see FIG. 12) covering the opening positioned at one side of the external housing 10, and the collar portion 12 arranged around the opening of the external housing 10, similarly to the embodiments 1 and 2.

Differently from the embodiments 1 and 2, the supporting frame 2 has a rectangular box-like shape whose one entire surface at one side is opened. A collar portion 27 is arranged around the opening of the supporting frame 2 to protrude externally. A rising portion 28 is formed at the external periphery of the collar portion 27 by bending with a substantial right angle. A pair of attaching holes 22, 22 is formed on the bottom surface of the supporting frame 2 to penetrate the bottom surface. The supporting frame 2 is configured to be fitted into the fixation hole that is formed on the ceiling or the like as the locating portion of the lighting apparatus, and clamped and fixed by the attachment screws that are passed through the attaching holes 22, 22. It should be noted that the locating portion of the supporting frame 2 is not limited to the fixation hole described above. It may be attached directly to the ceiling.

Additionally, the power circuit for supplying power to the light source module inside the external housing 10 in the embodiment 3 is arranged in the circuit box 13 fixed on the bottom surface inside the supporting frame 2, as shown in FIG. 13. Each light source module is connected to the power circuit in the circuit box 13 through an electric supply line that is not shown in drawings.

The supporting frame 2 has the size enough for containing the external housing 10 of the light source unit 1. The collar portion 27 of the supporting frame 2 has the width shorter than the collar portion 12 of the light source unit 1. Thus, it is configured as shown in FIGS. 10 and 11 that the collar portion 27 is contained at the inner side of the collar portion 12 and the rising portion 28 positioned at the external periphery of the collar portion 27 is opposed to the internal side of the rising portion 14 positioned at the external periphery of the collar portion 12.

The configured light source unit 1 and supporting frame 2 as described above are connected on one side of the supporting frame 2 by the hinges 4, 4 disposed on an opposing portion between the rising portion 14 and the rising portion 28, as shown in FIG. 11. The light source unit 1 is configured to be detached from the supporting frame 2 when the light source unit 1 is rotated about the hinges 4, 4 as the rotation axis.

In addition, the stoppers 3, 3 are arranged on an opposing portion between the rising portion 14 and the rising portion 28 on the other side of the supporting frame 2. These stoppers 3 are configured similarly to the stopper 3 shown in the embodiments 1 and 2, and attached in the rotatable manner between the locking condition and the lock releasing condition. The window holes 15, 15 are formed at positions corresponding to the stoppers 3, 3 on the rising portion 14. In addition, stop concave portions 29, 29 (see FIG. 13) are formed at positions corresponding to the stoppers 3, 3 on the rising portion 28.

The light source unit 1 can be attached to the supporting frame 2 by the procedure that the light source unit 1 in the detached condition shown by FIGS. 12 and 13 is rotated about the hinges 4, 4 as the rotation axis in a direction for bringing it close to the supporting frame 2, the stoppers 3, 3 are shifted into the locking condition by the rotation of the operating pieces 30, 30, and the functioning pieces 31, 31 are fastened to the respectively corresponding stop concave portions 29, 29.

FIG. 10 shows one stopper 3 at one side (left side in the drawing) as in the locking condition, and shows another stopper 3 at the other side (right side in the drawing) as in the lock releasing condition. The operation of the stopper 3 for shifting from the lock releasing condition to the locking condition is easily implemented by the procedure that a portion protruding from the window hole 15 is gripped, the stopper 3 is rotated, and the stopper 3 is pushed into the window hole 15 by direct hand. On the other hand, the stopper 3 in the locking condition is contained at the internal side of the collar portion 12. Therefore, it is possible to avoid the unintentional detachment of the light source unit 1 caused by the external force applied in the use condition. A tool, such as a screwdriver, is required in order to shift into the lock releasing condition, as described above. Thus, a user cannot detach the light source unit 1, easily.

Any of the stoppers 3, 3 and hinges 4, 4 are contained at the internal side of the collar portion 12 and have no portion protruding to the outside, in the attaching condition of the light source unit 1. Thus, it is not disfigured in the use condition. The lighting apparatus regarding the embodiment 3 includes only the window hole 15 at the outer side of the light source unit 1 which opens on the rising portion 14 positioned at one side of the collar portion 12. Therefore, the lighting apparatus regarding the embodiment 3 looks great in the use condition.

The stopper 3 regarding the above embodiments is configured to rotate about the supporting axis 17 for implementing the locking condition and the lock releasing condition. However, it may be configured that the locking condition and the lock releasing condition are implemented by the movement in the longitudinal direction or the like, instead of the rotation. For example, it may utilize a mechanism, in which a rod-like or plate-like stopping portion protruding from the window hole 15 is arranged in the lock releasing condition, the stopping portion is pushed toward the side of the window hole 15 to be slid at the internal side of the window hole 15, and the fastening unit of the stopping portion pushed into the internal side of the window hole 15 is fastened to the light source unit or the supporting frame. Although protruding in the lock releasing condition, the stopping portion of this mechanism is contained into the lighting apparatus through the window hole 15 in the locking condition. Therefore, this mechanism also can lead the advantages similar to those of the above embodiments 1-3.

It is explained in the above embodiments that the light source unit 1 is held by the supporting frame 2 to arrange the collar portion 12 of the light source unit 1 at the external side of the supporting plate 24 of the supporting frame 2. However, it may be configured that the light source unit 1 is held by the supporting frame 2 to arrange the collar portion 12 of the light source unit 1 at the internal side of the supporting plate 24 of the supporting frame 2, the stopper 3, the window hole 15 and the like are arranged on the supporting plate 24, and the functioning piece working as the fastening unit is fastened to the light source unit 1.

In addition, the stopper 3 may be arranged on the supporting plate 24 positioning at the internal side of the collar portion 12, although the stopper 3 in the explanation of above embodiments is arranged on the collar portion 12 positioning at the external side of the supporting plate 24.

As this invention may be embodied in several forms without departing from the sprit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1-5. (canceled)

6. A lighting apparatus, comprising:
a light source unit that includes a light source;
a holding member that holds the light source unit; and
a locking mechanism that locks the light source unit to the holding member in a holding condition with an operation of a lock operating unit,
wherein the locking mechanism is arranged for keeping the lock operating unit contained in the lighting apparatus, so as to prevent a lock from being released by a function of an unintentional force externally applied in a locking condition.

7. The lighting apparatus according to claim 6,
wherein the lock operating unit operates to shift from a lock releasing condition to the locking condition directly by hand.

8. The lighting apparatus according to claim 6,
wherein the locking mechanism includes:
a fastening unit that is fastened to one of the light source unit and the holding member, by the operation of the lock operating unit; and
a restricting unit that restricts a release of a fastening condition of the fastening unit.

9. The lighting apparatus according to claim 8,
wherein the locking mechanism includes a rotation axis that pivots the lock operating unit and rotates the lock operating unit to move the fastening unit.

10. The lighting apparatus according to claim 6,
wherein the holding member includes a pivoting unit that pivots the light source unit at another end side opposing to one end side on which the locking mechanism is positioned.

11. A lighting apparatus, comprising:
a light source unit that includes a light source;
a holding member that holds the light source unit; and
a locking mechanism that locks the light source unit to the holding member in a holding condition and releases the lock, with an operation of a lock operating unit,
wherein the locking mechanism is arranged for:
attaching the lock operating unit in a rotatable manner between a locking condition and a lock releasing condition; and
keeping the lock operating unit contained in the lighting apparatus while making the lock operating unit in the lock releasing condition that protrudes externally from the lighting apparatus rotate and shifting to the locking condition, so as to prevent a lock from being released by a function of an unintentional force externally applied in the locking condition.

12. The lighting apparatus according to claim 11, further comprising
a window hole arranged at a position adjacent to the locking mechanism,
wherein the locking mechanism includes:
a fastening unit that is fastened to one of the light source unit and the holding member, by the operation of the lock operating unit; and
a rotation axis that pivots the lock operating unit and rotates the lock operating unit to move the fastening unit, and
wherein the lock operating unit is contained in the lighting apparatus through the window hole while rotating to make the fastening unit fastened to the one.

13. The lighting apparatus according to claim 11,
wherein a pair of the locking mechanisms is arranged on an outer periphery of the lighting apparatus, and
wherein the lock operating unit in one of the locking mechanisms shifts to the lock releasing condition by a rotation operation with a reverse direction to a rotation operation of the lock operating unit in the other one of the locking mechanisms.

14. The lighting apparatus according to claim 11, further comprising
an engaging claw that is engaged with the holding member by sliding the light source unit in a condition where the light source unit is held on the holding member.

15. The lighting apparatus according to claim 14,
wherein the holding member includes:
a stop concave portion to which the fastening unit is fastened; and
an engagement concave portion with which the engaging claw is engaged.
